(19) United States
(12) Patent Application Publication
(10) Pub. No.: US 2007/0103393 A1
(43) Pub. Date: May 10, 2007

(54) Plasma display and driving method thereof

(76) Inventor: Du-Yeon Han, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/590,956

(22) Filed: Nov. 1, 2006

(30) Foreign Application Priority Data
Nov. 7, 2005 (KR) 10-2005-0105930

(51) Int. Cl. G09G 3/28

(52) U.S. Cl. 345/60

(57) ABSTRACT

In a plasma display device, a plurality of row electrodes performing a display operation are divided into first and second row groups, and row electrodes of first and second row groups are divided into a plurality of sub-groups. In a first subfield of a first subfield group among the plurality of subfields, performed is selecting non-light emitting cells among discharge cells of one sub-group among the plurality of sub-groups of the first row group during a first period, sustain-discharging light emitting cells of at least one first sub-group among the sub-groups of the second row group, and not sustain-discharging light emitting cells of at least one second sub-group among the plurality of sub-groups. Accordingly, each subfield can express different weight values, and the length of one subfield can be reduced since a sustain discharge is generated in one row group while non-light emitting cells are selected in another row group.

### CROSS-REFERENCE TO RELATED APPLICATION

This application claims priority to and the benefit of Korean Patent Application No. 10-2005-0105930 filed in the Korean Intellectual Property Office on Nov. 7, 2005, the entire contents of which is incorporated herein by reference.

### BACKGROUND OF THE INVENTION

(a) Field of the Invention

The present invention relates to a plasma display device and a driving method thereof.

(b) Description of the Related Art

A plasma display device is a flat panel display that uses plasma generated by a gas discharge process to display characters or images. It includes, depending on its size, more than several scores to millions of pixels arranged in a matrix pattern.

Generally, in a plasma display device, a field (e.g., 1 TV field) is divided into respectively weighted subfields. Grayscales may be expressed by a combination of weights from among the subfields, which are used to perform a display operation. A turn-on discharge cell is selected from among a plurality of discharge cells by performing an addressing discharge for an address period of each subfield, and the turn-on discharge cell is sustain-discharged during a period corresponding to a weight of the corresponding subfield in a sustain period of each field so as to display an image.

The plasma display device uses a plurality of subfields, each having a different weight so as to express grayscales. A sum of weight values of subfields having discharge cells in the light emitting state among a plurality of subfields represents a gray scale of the corresponding discharge cell. However, expressing gray scales using subfields may cause a dynamic false contour. For example, when using subfields with weights set to 2ⁿ, a dynamic false contour may occur when a discharge cell expresses grayscales of 127 and 128 in consecutive fields.

When temporally dividing an address period and a sustain period, an additional address period is provided to each subfield for addressing all discharge cells in addition to the sustain period for sustain-discharging, thereby increasing the length of a subfield. Accordingly, a length of a subfield is increased and a number of subfields that are usable in a field may be limited.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a plasma display device having advantages of reducing false contour and reducing the length of a subfield, and a driving method thereof.

An exemplary driving method according to an embodiment of the present invention relates to driving a plasma display device by a plurality of subfields divided from a frame, the plasma display device having a plurality of row electrodes, a plurality of column electrodes, and a plurality of discharge cells respectively formed by the row and column electrodes. In the exemplary driving method, the plurality of row electrodes are divided into a first row group and a second row group, row electrodes of the first row group are divided into a plurality of sub-groups, and row electrodes of the second row group are divided into a plurality of sub-groups. In addition, in a first subfield of a first subfield group among the plurality of subfields, non-light emitting cells are selected from among discharge cells of one sub-group among the plurality of sub-groups of the first row group during a first period, light emitting cells of at least one first sub-group among the sub-groups of the second row group are sustain-discharged, and light emitting cells of at least one second sub-group among the plurality of sub-groups are not sustain-discharged. In the first subfield, non-light emitting cells are selected from among light emitting cells of a sub-group among the plurality of sub-groups of the second row group during a second period, light emitting cells of at least one third sub-group among the plurality of sub-groups of the first row group are sustain-discharged, and light emitting cells of at least one fourth sub-group among the plurality of sub-groups of the first row group are not sustain-discharged.

An exemplary plasma display device according to an embodiment of the present invention includes a plasma display panel (PDP), a controller, and a driver. The PDP includes a plurality of row electrodes that perform a display operation, a plurality of column electrodes formed to cross the row electrodes, and a plurality of discharge cells formed by the plurality of row electrodes and the plurality of column electrodes. The controller divides one field into a plurality of subfields, divides the plurality of row electrodes into a first row group and a second row group, divides row electrodes of the first row group into a plurality of sub-groups, and divides row electrodes of the second row group into a plurality of sub-groups. The driving drives the plurality of row and column electrodes. In at least one first subfield of a plurality of consecutive first subfields among the plurality of subfields, the driver selects non-light emitting cells from light emitting cells of the respective sub-groups during a first period of the respective sub-groups of the first row group, sustain-discharges the light emitting cells of at least one first sub-group among the plurality of sub-groups of the second row group, and non sustain-discharges light emitting cells of at least one second sub-group among the plurality of sub-groups of the second row group. In addition, in the first subfield, the driver selects non-light emitting cells from light emitting cells of the respective sub-groups during a second period of the respective sub-groups of the second row group, sustain-discharges light emitting cells of at least one third sub-group among the plurality of sub-groups of the first row group, and non sustain-discharges light emitting cells of at least one fourth sub-group among the plurality of sub-groups of the first row group.

### BRIEF DESCRIPTION OF THE DRAWINGS

FIG. 1 shows a plasma display device according to an exemplary embodiment of the present invention.

FIG. 2 shows grouping of electrodes respectively applied to a driving method for a plasma display device according to an exemplary embodiment of the present invention.

FIG. 3 shows a driving method for a plasma display device according to a first exemplary embodiment of the present invention.

FIG. 4 shows the driving method of FIG. 3 applied to subfields.

FIG. 5 shows a grayscale expression method using the driving method of FIG. 3.

FIG. 6A to FIG. 6C respectively show driving waveforms of a plasma display device for realizing weights of first to sixth subfields SF1 to SF6 of a first subfield group.

FIG. 7 shows a driving circuit of a scan electrode driver 400 for generation of the driving waveforms of FIG. 6A to FIG. 6C.

FIG. 8 and FIG. 9 schematically show a driving method of a plasma display device according to a second exemplary embodiment and a third exemplary embodiment of the present invention, respectively.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. Throughout this specification and the claims that follow, unless explicitly described to the contrary, the word “comprises/includes” or variations such as “comprises/includes” or “comprising/including” will be understood to imply the inclusion of stated elements but not the exclusion of any other elements.

Wall charges mentioned in the following description mean charges formed and accumulated on a wall (e.g., a dielectric layer) close to an electrode of a discharge cell. A wall charge will be described as being “formed” or “accumulated” on the electrodes, although the wall charges do not actually touch the electrodes. Further, a wall voltage means a potential difference formed on the wall of the discharge cell by the wall charge.

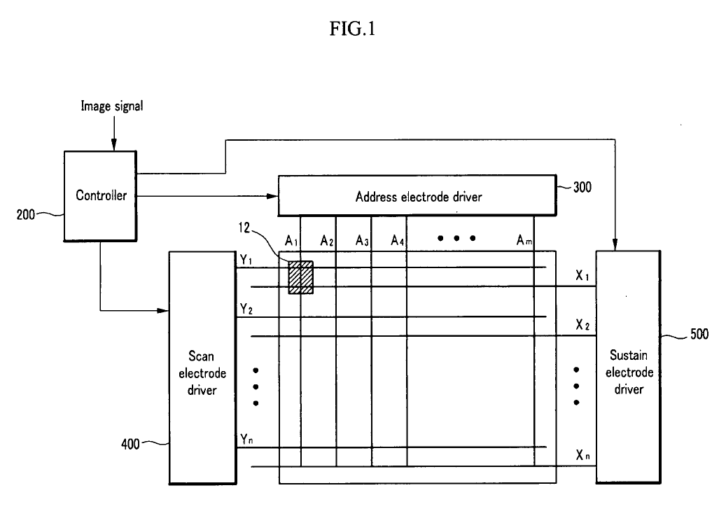

A plasma display device according to an exemplary embodiment of the present invention will now be described in more detail with reference to FIG. 1.

FIG. 1 shows a plasma display device according to an exemplary embodiment of the present invention.

As shown in FIG. 1, the plasma display device includes a plasma display panel (PDP) 100, a controller 200, an address electrode driver 300, a scan electrode driver 400, and a sustain electrode driver 500.

The PDP 100 includes a plurality of address electrodes A1 to Am extending in a column direction, and a plurality of sustain electrodes X1 to Xn and a plurality of scan electrodes Y1 to Yn extending in a row direction as pairs. Hereinafter, the address electrode, the sustain electrode, and the scan electrode will be respectively referred to as an A electrode, an X electrode, and a Y electrode. Generally, the X electrodes X1 to Xn are respectively formed to correspond to the Y electrodes Y1 to Yn, and the X and Y electrodes perform a display operation in order to display an image during a sustain period. The Y electrodes Y1 to Yn and the X electrodes X1 to Xn may perpendicularly cross each other. A discharge space formed at a crossing region of the A electrodes A1 to Am with the sustain and scan electrodes X₁ to Xₙ and Y₁ to Yₙ forms a discharge cell 12. This structure of the PDP 100 is merely exemplary, and panels of other structures can be used in the present invention as well. Hereinafter, an X electrode and an Y electrode extending in a row direction as a pair will be called row electrodes, and an A electrode extending in a column direction will be called a column electrode.

The controller 200 externally receives video signals and outputs an A electrode driving control signal, an X electrode driving control signal, and a Y electrode control signal. In addition, the controller 200 controls the plasma display device by dividing a frame into a plurality of subfields, and divides a plurality of row electrodes into a first group and a second group. The controller 200 then controls the row electrodes of the first and second groups by dividing them respectively into a plurality of sub-groups.

The address electrode driver 300 receives an A electrode driving control signal from the controller 200, and applies a display data signal for selecting discharge cells to be displayed to the respective A electrodes.

The scan electrode driver 400 receives the Y electrode driving control signal from the controller 200, and applies a driving voltage to the Y electrode.

The sustain electrode driver 500 receives the X electrode driving control signal from the controller 200 and applies a driving voltage to the X electrode.

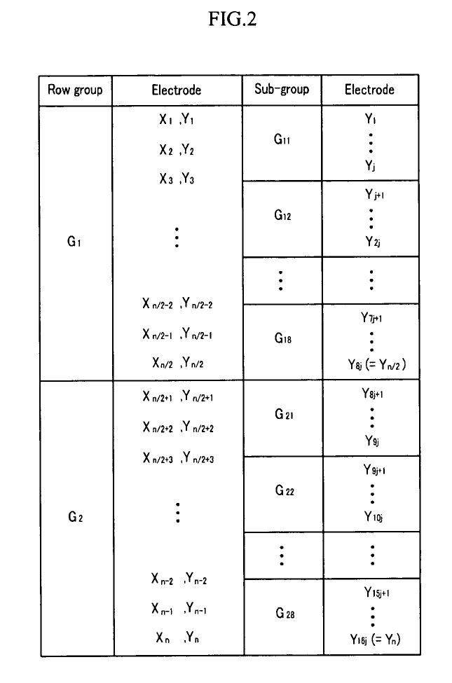

A driving method for driving the plasma display device according to an exemplary embodiment of the present invention will now be described with reference to FIG. 2.

FIG. 2 shows a division structure of each electrode for the driving method of the plasma display device according to the exemplary embodiment of the present invention.

As shown in FIG. 2, in a field, a plurality of row electrodes X₁ to Xₙ and Y₁ to Yₙ are divided into two row groups G₁ and G₂. A plurality of row electrodes X₁ to X_{n/2}, Y₁ to Y_{n/2} formed in a top portion of the PDP 100 may be grouped into a first row group G2 and a plurality of row electrodes X_{(n/2)+1} to Xₙ and Y_{(n/2)+1} to Yₙ formed in a bottom portion of the PDP 100 may be grouped into a second row group G2, or even-numbered row electrodes may be grouped into a first row group G1 and odd-numbered row electrodes may be grouped into a second row group G2. In addition, a plurality of Y electrodes in the respective first and second row groups G₁ and G₂ are divided into a plurality of sub-groups G₁₁ to G₁₈, and G₂₁ to G₂₈. It is assumed in FIG. 2 that the first and second row groups G1 and G2 are respectively divided into eight sub-groups G₁₁ to G₁₈ and G₂₁ to G₂₈.

That is, the first Y electrode to the j-th Y electrode Y₁ to Yⱼ are grouped into the first sub-group G₁₁, and the (j+1)th Y electrode to the 2j-th Y electrode Yⱼ₊₁ to Y₂ⱼ are grouped into the second sub-group G₁₂ in the first row group G₁. In this manner, the (7j+1)th Y electrode to the (n/2)th Y electrode Y₇ⱼ₊₁ to Y_{n/2} are grouped into the eighth sub-group G₈ (where j is an integer between 1 and n/16). In a like manner, the (8j+1)th Y electrode to the 9j-th Y electrode (Y₈ⱼ₊₁ to Y₉ⱼ are grouped into a first sub-group G₂₁,and the (9j+1)th Y electrode to the 10j-th Y electrode Y₉ⱼ₊₁ to Y₁₀ⱼ are grouped into a second sub-group G₂₂ , in the second row group G₂. Also, the (15j+1)th Y electrode to the n-th Y electrode Y₁₅ⱼ₊₁ to Yₙ are grouped into the eighth sub-group G₂₈. On the other hand, Y electrodes having a constant distance from each other in the first and second row groups G₁ and G₂ may be grouped into one sub-group, and the Y electrodes can be grouped according to an irregular method as necessary.

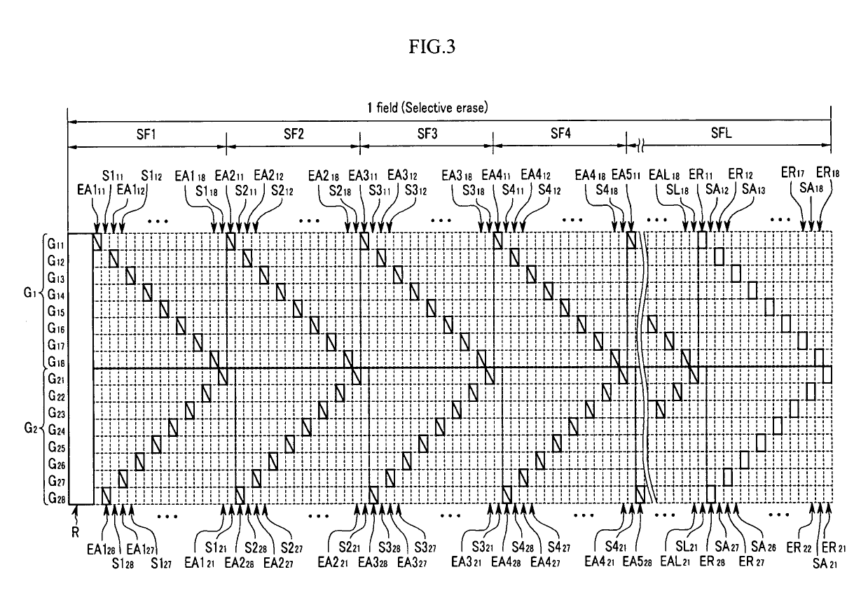

FIG. 3 shows a driving method for driving a plasma display device according to a first exemplary embodiment of the present invention. In the first exemplary embodiment of the present invention, a length of an address period is the same as that of a sustain period, and the sustain periods of each subfield are of the same length.

Referring to FIG. 3, each field is formed of a plurality of subfields SF1 to SFL. The first to the L-th subfields SF1-SFL are respectively formed with address periods EA1₁₁ to EAL₁₈ and EA1₂₁ to EAL₂₈ and sustain periods S1₁₁ to SL₁₈ and S1₂₁ to SL₂₈, and a selective erase method is applied to the address periods EA1₁ to EAL₈ of the respective first to L-th subfields SF1 to SFL. As described above with reference to FIG. 2, a plurality of row electrodes X₁ to Xₙ and Y₁ to Yₙ are respectively grouped into two groups (a first row group G₁ and a second row group G₂), and the first and second row groups G₁ and G₂ are respectively grouped into a plurality of sub-groups G₁₁ to G₁₈ and G₂₁ to G₂₈.

There are a selective writing method and a selective erase method for selecting discharge cells to emit light (hereinafter, referred to as light emitting cells) and discharge cells to emit no light (hereinafter, referred to as non-light emitting cells) that are selected from among a plurality of discharge cells. The selective writing method selects a light emitting cell and generates a constant wall voltage, and the selective erase method selects a non-light emitting cell and erases the wall voltage.

That is, cells in the non-light emitting state are address-discharged and thus wall charges are formed such that the non-light emitting state is switched to the light emitting state according to the selective writing method, and cells in the light emitting state are address-discharged and thus wall charges that had already been formed are erased such that the light emitting state is switched to the non-light emitting state according to the selective erase method. The address-discharge that forms the wall charge in the selective write method is called a “write discharge,” and the address discharge that erases the wall charge in the selective erase method is called an “erase discharge.”

Referring to FIG. 3, a reset period R is temporally provided before an address period EA1 of the first subfield SF1 in a temporal order among the first to L-th subfields in order to set the state of all discharge cells to be the light emitting cell state according to the selective erase method, the first to L-th subfields SF1 to SFL respectively having the address periods EA1₁₁ to EAL₁₈ and EA1₂₁ to EAL₂₈. In the reset period R, all discharge cells are reset to light emitting cells so that they can be erase-discharged in the address period EA1.

Subsequently, the address periods EA1₁₁, to EAL₁₈ and EA1₂₁ to EAL₂₈ and the sustain periods S1₁₁ to SL₁₈ and S1₂₁ to SL₂₈ of the first to eighth sub-groups G₁₁ to G₁₈ and G₂₁ to G₂₈ of the respective first and second row groups G₁ and G₂ of the first subfield SF1 are sequentially applied. At this time, the address periods EA1₁₁ to EAL₁₈ and the sustain periods S1₁₁ to SL₁₈ are sequentially applied from the first sub-group G₁₁ to the eighth sub-group G₁₈ in the first row group G₁, and the address periods EA12₁ to EAL₂₈ and the sustain periods S1₂₁ to SL₂₈ are sequentially applied from the eighth sub-group G₂₈ to the first sub-group G₂₁ in the second row group G₂.

That is, in the k-th subfield SFk of the first row group G₁, the sustain period Sk₁ᵢ of the i-th sub-group G₁ᵢ is applied after the address period EAk₁ᵢ of the i-th group G₁ᵢ is applied (where k is an integer between k and L, and i is an integer between 1 and 8). Subsequently, the address period EAk₁₍ᵢ₊₁₎ and the sustain period Sk₁₍ᵢ₊₁₎ are applied to the (i+1)th sub-group G₁₍ᵢ₊₁₎. In the k-th subfield SFk of the second row group G₂, the sustain period Sk₂₍ᵢ₊₁₎ of the (i+1)th sub-group G₂₍ᵢ₊₁₎ is applied after the address period EAk₂₍ᵢ₊₁₎ of the (i+1)th sub-group G₂₍ᵢ₊₁₎ is applied. Subsequently, the address period EAk₂ᵢ and the sustain period Sk₂ᵢ are applied to the i-th sub-group G₂ᵢ.

While the sustain period Sk₁ᵢ is applied to the i-th sub-group G₁ᵢ of the first row group G₁, the address period EAk₂₍₈₋₍ᵢ₊₁₎₎ is applied to the (8-(i−1))th sub-group G_{2 (8-(i-1))} of the second row group G₂ in the k-th subfield SFk. In the k-th subfield SFk, while the sustain period Sk_{2 (8-(i-1))} is applied to the (8-(i−1))th sub-group G_{2 (8-(i-1))} in the second row group G₂, the address period EAk₁₍ᵢ₊₁₎ is applied to the (i+1)th sub-group G₁₍ᵢ₊₁₎ in the first row group G₁.

Although it is illustrated in FIG. 3 that the address periods EAk₂₈ to EAk₂₁ and the sustain periods Sk₂₈ to Sk₂i are sequentially applied from the eighth sub-group G₂₈ to the first sub-group G₂₁ in the second row group G₂, the address periods EAk₂₁ to EAk₂₈ and the sustain periods Sk₂₁ to Sk₂₈ may be applied from the first sub-group G₂₁ to the eight sub-group G₂₈ in the second row group G₂ as in the first row group G₁. In addition, the address periods and the sustain periods may be applied to the first and second row groups G₁ and G₂ in a different order than that of FIG. 3.

The respective subfields SF1 to SFL of the first row group G₁ will now be described in more detail. Since address and sustain operations during the address period and the sustain period of the respective subfields SF1 to SFL are substantially the same, only address and sustain operations in the k-th subfield SFk will be described hereinafter (where k is an integer between 1 and L).

In the address period EAk₁₁ applied to the first sub-group G₁₁ of the first row group G₁, discharge cells to be in the non-light emitting state are erase-discharged to eliminate wall charges, and discharge cells in the light emitting cell state are sustain-discharged during the sustain period Sk₁₁. Subsequently, in the address period EAk₁₂ of the second sub-group G₂₁, discharge cells set to be in the non-light emitting state are erase-discharged to eliminate wall charges, and discharge cells in the light emitting cell state of the second sub-group G₁₂ are sustain-discharged during the sustain period sustain period Sk₁₂. At this time, the light emitting cells of the first sub-group G₁₁ are also sustain-discharged.

In the same way, the address periods EAk₁₃ to EAk₁₈ and the sustain periods Sk₁₃ to Sk₁₈ are also applied to the sub-groups G₁₃ to G₁₈. At this time, during a sustain period Sk₁ᵢ of an i-th sub-group G₁ᵢ, light-emitting cells of the first sub-group G₁ᵢ and light emitting cells of the first to (i−1)th sub-groups G₁₁ to G₁₍ᵢ₋₁₎ and the (i+1)th sub-group to the eight sub-group G₁₍ᵢ₊₁₎ to G₁₈ are sustain-discharged.

Herein, the light emitting cells of the first to (i−1)th sub-groups G₁₁ to G₁₍ᵢ₋₁₎ correspond to the light emitting cells that have not experienced an erase discharge during the address periods EAk₁₁ to EAk₁₍ᵢ₋₁₎ of the k-th subfield SFk, and the light emitting cells of the (i+1)th to eighth sub-groups G₁₍ᵢ₊₁₎ to G₁₈ correspond to the light emitting cells that have not experienced the erase discharge during the address periods EA(k−1)₁₍ᵢ₊₁₎ to EA(k−1)₁₈ of the (k−1) subfield SF(k−1).

In addition, the light emitting cells of the i-th sub-group G₁ᵢ are sustain-discharged until the sustain period SK₁₍ᵢ₋₁₎ immediately before a subsequent address period EA(k+1)₁ᵢ of the first group G₁ᵢ of the (k+1)th subfield. That is, the light emitting cells of the i-th sub-group G₁ᵢ are sustain-discharged during eight sustain periods.

Accordingly, the address periods EA2₁ to EA2₁₈, . . . , EAL₁₁ to EAL₁₈) and the sustain periods S2₁₁ to S2₁₈, . . . , SL₁₁ to SL₁₈ are applied to each sub-group G₁₁ to G₁₈ of the subfields SF1 to SFL. In this way, the discharge cells set to emit light during the reset period R are continuously sustain-discharged until they are erase-discharged in the respective subfields SF1 to SFL and thus changed to the non-light emitting cells. After the light emitting cells are switched to the non-light emitting cells due to the erase-discharge, no sustain discharge is generated in the corresponding subfield. At this time, a weight value of each subfield SF1 to SFL corresponds to a sum of the lengths of eight sustain periods in each subfield SF1 to SFL.

When the sustain period SL₁₈ of the eight sub-group G₁₈ is applied to the subfield SFL, the sustain discharge is performed by eight times in the first sub-group G₁₁, seven times in the second sub-group G₁₂, six times in the third sub-group G₁₃, five times in the fourth sub-group G₁₄, and four times in the fifth sub-groups G₁₅. Further, the sustain discharge is performed by three times in the the sixth sub-group G₁₆, twice in the seventh sub-group G₁₇, and once in the eighth sub-group G₁₈.

Accordingly, the first to eighth sub-groups G₁₁ to G₁₈ may have the same number of sustain discharges. For this purpose, the last subfield SFL of the first row group G₁ may have erase periods ER₁₁ to ER₁₇ and additional sustain periods SA₁₂ to SA₁₈.

In more detail, the first sub-group G₁₁ where the sustain discharge is performed by eight times immediately before subsequent erase periods may not need to experience an additional sustain discharge. Therefore, wall charges formed in the light emitting cells of the first sub-group G₁₁ are erased during the erase period ER₁₁. Then, the light emitting cells of the first to eighth sub-groups G₁₁ to G₁₈ emit light during the additional sustain discharge period SA₁₂. At this time, since the wall charges formed in the light emitting cells of the first sub-group G₁₁ were erased during the erase period ER₁₁, the additional sustain discharge is performed by once in the light emitting cells of the second to eighth sub-groups G₁₂ to G₁₈ during the additional sustain discharge period SA₁₂.

In addition, since the second sub-group G₁₂ where the sustain discharge is performed by eight times due to the addition sustain period SA₁₂ may not need to experience an additional sustain discharge, wall charges formed in the light emitting cells of the second sub-group G₁₂ are erased during the erase period ER₁₃. Then, the light emitting cells of the first to eight sub-groups G₁₁ to G₁₈ emit light during the addition sustain period SA₁₃. At this time, since the wall charges formed in the light emitting cells of the first and second sub-groups G₁₁ and G₁₂ were erased during the respective erase periods ER₁₁ and ER₁₂, the additional sustain discharge is performed by once in the light emitting cells of the third to eighth sub-groups G₁₃ to G₁₈ during the addition sustain period SA₁₃.

In addition, wall charges formed in the light emitting cells of the third sub-group G₁₃ are erased during the erase period ER₁₃ since the third sb-group G₁₃ where the sustain discharge is performed by eight times in third sub-group G₁₃ due to the addition sustain period SA₁₃ may not need to experience an addition sustain discharge. Then, the light emitting cells of the first to eighth sub-groups G₁₁ to G₁₈ emit light during the addition sustain period SA₁₄. At this time, since the wall charges formed in the first to third sub-groups G₁₁ to G₁₃were erased during the respective erase periods ER₁₁ to ER₁₃, the addition sustain discharge is performed once in the light emitting cells of the fourth to eighth sub-groups G₁₄ to G₁₈ respectively during the addition sustain period SA₁₄.

An erase period ER₁₈ may be provided after the additional period SA₁₈ of the eighth sub-group G₁₈ so as to erase wall charges of the eighth sub-group G₁₈. Also, since the reset period R is applied to a first subfield SF1 of a consecutive field, the erase period ER₁₈ of the eighth sub-group G₁₈ may not be formed. The erase operation may also be sequentially applied to each row electrode of the respective sub-groups during the erase periods ER₁₁ to ER₁₈ similar to the address operation, or may be simultaneously applied to the entire row electrodes of the respective row groups.

Subfields SF1 to SFL of the second row group G₂ will now be described. A structure of each subfield SF1 to SFL of the second row group is substantially equivalent to that of each subfield SF1 to SFL of the first row group G₁. However, as previously described, the address periods EA1₂₈-EA1₂₁, . . . , EAL₂₈-EAL₂₁ are applied from the eighth sub-group G₂₈ to the first sub-group G₂₁ in the respective subfields SF1 to SFL of the second row group G₂, and the erase periods ER₂₁ to ER₂₈ are also applied from the eighth sub-group G₂₈ to the first sub-group G₂₁ in the last subfield SFL of the second row group G₂.

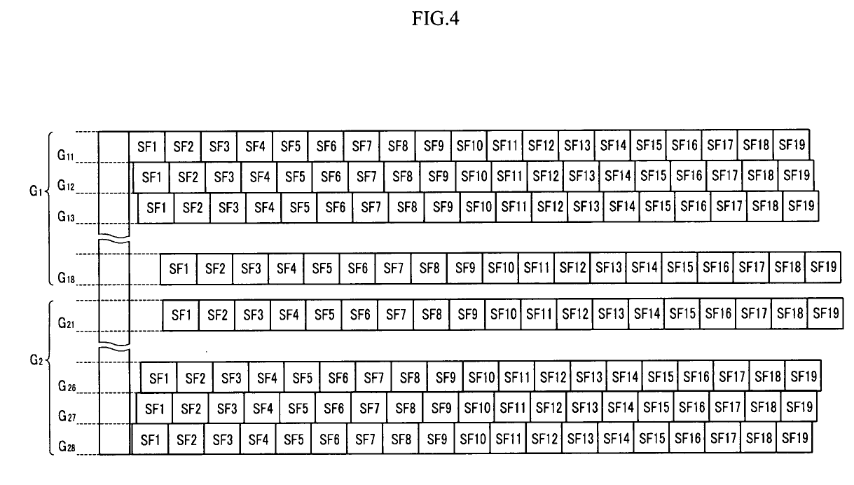

Such a driving method of the plasma display device can be described only with subfields as shown in FIG. 4. In FIG. 4, one field is formed of 19 subfields SF1 to SF19. It is illustrated in FIG. 4 that sub-groups G₁₁ to G₁₈ and G₂₈ to G₂₁ respectively have a plurality of subfields SF1 to SF19 that form one field and that the plurality of subfields are shifted by a predetermined distance from each other. At this time, the predetermined distance corresponds to a sum of an address period EAk₁ᵢ or EAk₂ᵢ of one sub-group G₁ᵢ or G₂ᵢ and a sustain period Sk₁ᵢ or Sk₂ᵢ of one sub-group G₁ᵢ or G₂ᵢ.

In the case of assuming that the length of the address period EAk₁ᵢ or EAk₂ᵢ of one of sub-groups G₁ᵢ and G₂ᵢ corresponds to the length of the sustain period Sk₁ᵢ or Sk₂ᵢ of one of sub-groups G₁ᵢ and G₂ᵢ, a starting point of the respective subfields SF1 to SFL of the second row group G₂ is shifted by a distance between a starting point of the respective subfields SF1 to SFL of the first row group G₁ and the address period EAk₁ᵢ or EAk₂ᵢ.

Accordingly, the row electrodes of the second row group G₂ can be applied with the sustain period during the address period of the row electrodes of the first row group G₁, and the row electrodes of the first row group G₁ can be applied with the sustain period during the address period of the row electrodes of the second row group G₂. That is, the sustain period can be applied during the address period rather that dividing the address period and the sustain period, thereby reducing the length of a subfield. In addition, prime particles formed during the sustain period can be efficiently used during the address period since the address period is provided between sustain periods of each sub-group such that a scan pulse width can be reduced, thereby achieving high-speed scan.

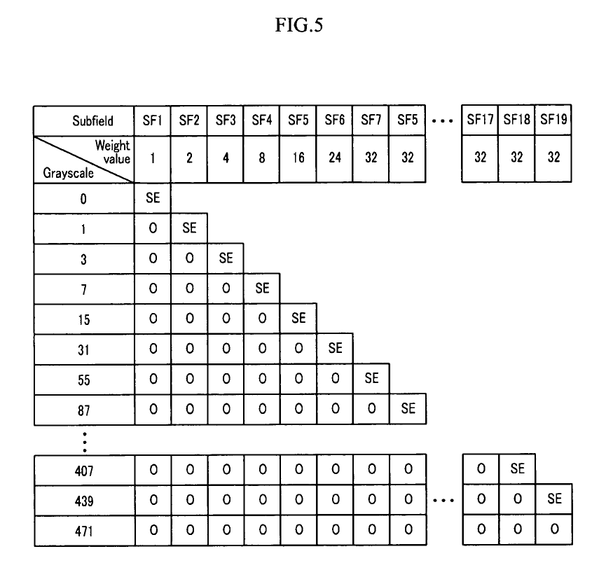

FIG. 5 shows a grayscale expression method using the driving method of FIG. 3. It is illustrated in FIG. 5 that one field is formed of 19 subfields. In addition, “SE” denotes that light emitting cells are switched non-light emitting cells due to an erase discharge in the corresponding subfield, and “o” denotes a subfield having discharge cells in the light emitting state.

As shown in FIG. 5, the subfields SF1 to SF19 are divided into first and second subfield groups. In addition, weight values of the subfields SF1 to SF6 of the first subfield group are respectively set to 1, 2, 4, 8, 16, and 24, and weight values of the subfields SF7 to SF19 of the second subfield group are set to 32.

When light emitting cells are erase-discharged during an address period of the first subfield SF1 among the subfields SF1 to SF19 and thus they are switched to non-light emitting cells, the first subfield SF expresses a grayscale of 0 since a sustain discharge is not generated during a sustain period in the first subfield SF1 and thus the sustain discharge is not generated in the next subfields SF2 to SF19. Subsequently, when the light emitting cells are erase-discharged during the address period of the second subfield SF2 and thus they are switched to the non-light emitting cells, the second subfield SF2 expresses a grayscale of 1 since no sustain discharge is generated from the second subfield SF2.

When the light emitting cells that have not experienced the erase discharge during the address period of the second subfield SF2 are erase-discharged during an address period of the third subfield SF3, the light emitting cells are switched to the non-light emitting cells and thus the third subfield SF3 expresses a grayscale of 3.

That is, in the case that light emitting cells are erase-discharged in the k-th subfield and thus the cells are changed to non-light emitting cells, discharge cells in the light emitting state are continuously sustain-discharged from the first to the (k−1)th subfield and thus a gray scale that corresponds to a sum of the weight values of the first to (k−1) subfields can be expressed.

At this time, a grayscale that cannot be expressed by a sum of subfields can be expressed by using a dithering algorithm. Such a dithering algorithm approximates a grayscale from a combination of specific grayscales within a predetermined range when the required grayscale is not available. For example, grayscales between a grayscale 31 and a grayscale 55 can be expressed by dithering the grayscales 31 and 55 in a predetermined pixel area.

In general, since the human eye recognizes a grayscale difference better between low grayscales than between high grayscales, expression of low grayscales may be degraded when the low grayscales are expressed by using the dithering algorithm rather than using a combination of subfields. However, a combination of subfields SF1 to SF6 of the first subfield group may precisely express grayscales 1, 3, 7, 15, 31, and 55 by setting the subfields SF1 to SF6 of the first subfield group to have different weight values from each other as shown in FIG. 5.

As described, the grayscales are expressed by the consecutive subfields SF1 to SF19 until discharge cells in the light emitting state are erase-discharged in the corresponding subfield so that they are changed to the non-light emitting state such that an occurrence of contour noise can be avoided according to the first exemplary embodiment of the present invention. In addition, the discharge cells that are changed to the light emitting state during the reset period R are continuously sustain-discharged until they are erase-discharged and thus switched to the non-light emitting cells, and therefore any grayscale can be expressed by a maximum of one sustain discharge. As a result, power consumption caused by erase discharging is reduced.

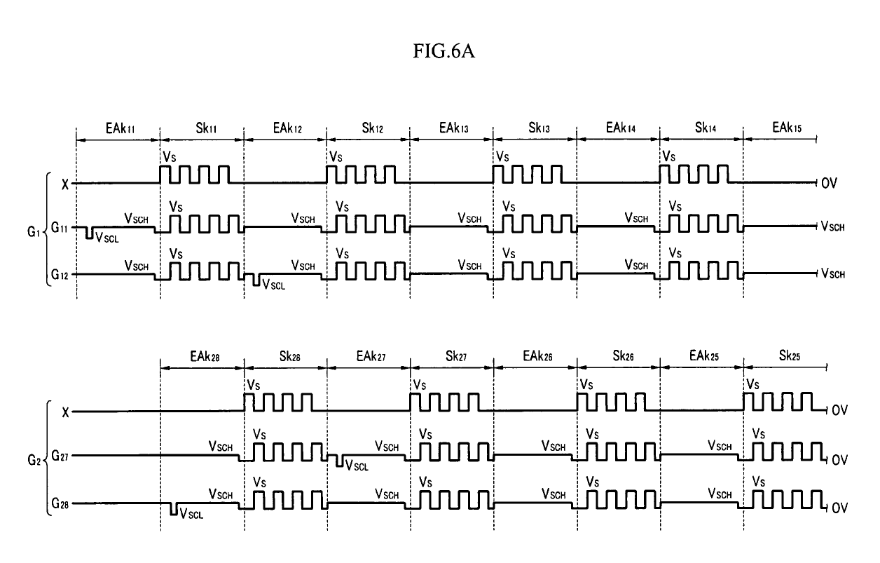

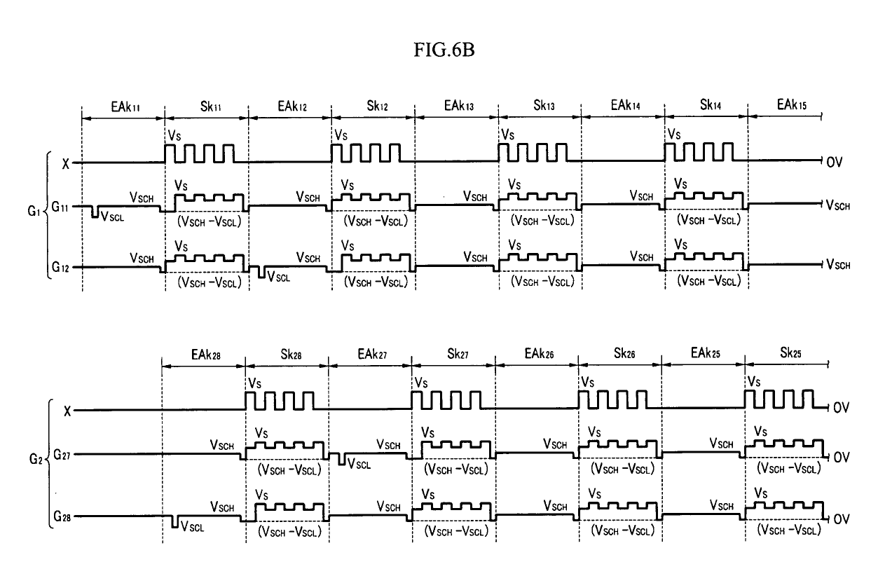

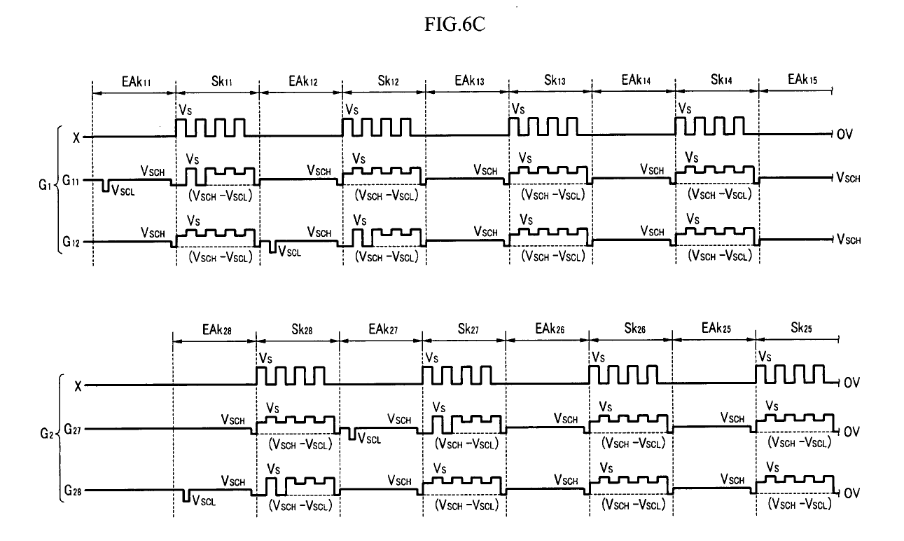

A method for realizing weight values of the subfields SF1 to SF6 of the first group will now be described with reference to FIG. 6A to FIG. 6C.

FIG. 6A to FIG. 6C respectively illustrate driving waveforms of the plasma display device for realizing weight values of the subfields SF1 to SF6 of the first subfield group. For convenience of description, the first and second sub-groups G₁₁ and G₁₂ of the first row group G₁ and the seventh and eighth sub-groups G₂₇ and G₂₈ of the second row groups G₂ in one subfield SFi are illustrated in FIG. 6A to FIG. 6C, and a driving waveform applied to the A electrode and a description thereof are omitted.

As shown in FIG. 6A, a scan pulse having a voltage of V_{SCL} is sequentially applied to the plurality of Y electrodes of the first sub-group G₁₁ while the X electrodes of the first row group G₁ are applied with a reference voltage (e.g., 0V in FIG. 6A) during the address period EAk₁₁ of the first sub-group G₁₁ in the k-th subfield SFk of the first row group G₁. At this time, an address pulse (not shown) having a positive voltage is applied to an A electrode of a cell to be selected as a non-light emitting cell from light emitting cells that are formed by the Y electrodes to which the scan pulse is applied.

In addition, a Y electrode to which the scan pulse is not applied is applied with a voltage of V_{SCH} that is higher than the V_{SCL} voltage, and an A electrode to which the address pulse is not applied is applied with the reference voltage. As a result, the light emitting cells to which the V_{SCL} voltage of the scan pulse and the positive voltage of the address pulse are applied are erase-discharged and thus wall charges formed in the X and Y electrodes are erased and the light emitting cells are changed to the non-light emitting cells.

In the sustain period Sk₁₁, a high level voltage (Vs voltage in FIG. 6) and a low level voltage (0V in FIG. 6) in opposite phase are applied to the plurality of X electrodes of the first row group G₁ and the Y electrodes of the first and second sub-groups G₁₁ and G₁₂ such that the light emitting cells of the first sub-group are sustain-discharged. That is, the Y electrode is applied with 0V when the Vs voltage is applied to the X electrode, and the X electrode is applied with 0V when the Y electrode is applied with the Vs voltage. At this time, since cells that have not been erase-discharged during the address period EAk₁₁ are in the light emitting state, a sustain discharge is generated in cells that will not experience an erase discharge during the address period EAk₁₁.

Subsequently, in the address period EAk₁₂ of the second sub-group G₁₁, the scan pulse having the V_{SCL} voltage is sequentially applied to the plurality of Y electrodes of the second sub-group G₁₂ while the reference voltage is applied to the X electrode of the first row group G₁, and an address pulse (not shown) having a positive voltage is applied to an A electrode of a cell to be selected as a non-light emitting cell from light emitting cells that are formed by the Y electrodes to which the scan pulse is applied.

In addition, the sustain pulses of inverse phases are respectively applied to the plurality of Y electrodes of the first row group G₁ and the Y electrodes of the first and second sub-groups G₁₁ and G₁₂ during the sustain period Sk₁₂ such that the light emitting cells are sustain-discharged. The address periods EAk₁₃ to EAk₁₈ and the sustain periods Sk₁₃ to Sk₁₈ are applied to the sub-groups G₁₃-G₁₄ in a manner like the above.

While the sustain period Sk₁₁ is applied to the first sub-group G₁₁ of the k-th subfield of the first row group G₁, the address period EAk₂₈ is applied to the eighth sub-group of G₂₈ of the second row group G₂. In the k-th subfield SFk of the second row group G₂, the scan pulse having the V_{SCL} voltage is applied to the plurality of Y electrodes of the eighth sub-group G₂₈ while the reference voltage is applied to the X electrode of the second row group G₂ during the address period EAk₂₈, and an address pulse (not shown) having a positive voltage is applied to an A electrode of a cell to be selected as a non-light emitting cell from light emitting cells that are formed by the Y electrodes to which the scan pulse is applied.

In the sustain period Sk₂₈, the sustain pulses of inverse phases are respectively applied to the plurality of X electrodes of the second row group G₂ and the Y electrodes of the eighth and the seventh sub-groups G₂₈ and G₂₇ such that the light emitting cell is sustain-discharged. In addition, while the sustain period S₂₈ is applied to the k-th subfield SFk of the second row group G₂, the address sustain period Eki₁₂ is applied to the second sub-group G₁₂ of the first row group G₁. The address periods EAk₂₇ to EAk₂₁ and the sustain periods Sk₂₇ to Sk₂₁ are respectively applied to the sub-groups G₂₇ to G₂₁ in a manner like the above.

For example, assume that a weight value of the k-th subfield SFk of FIG. 6 is 32. In this assumption, the length of each sustain period Sk₁₁ to Sk₁₈ or Sk₂₁ to Sk₂₈ of each sub-group G₁₁ to G₁₈ or G₂₁ to G₂₈ of one of the first and second row groups G₁ or G₂ in the k-th subfield SFk corresponds to a weight of 4. Also, four sustain discharge pulses are respectively applied to the X electrode and the Y electrode during the respective sustain periods Sk₁₁ to Sk₁₈ and Sk₂₁ to Sk₂₈.

A weight value of 1 corresponds to a quarter of the length of any sustain period Sk₁ⱼ among the sustain periods of the respective sub-groups G₁₁ to G₁₈ or G₂₁ of one of the first and second row groups G₁ and G₂ (where j is an integer between 1 and 8). Therefore, as shown in FIG. 6B, in the k-th subfield SFk of the first row group G₁, after one sustain pulse is applied to the Y electrode of the first sub-group G₁₁ during the sustain period Sk₁₁ of the first sub-group G₁₁, a voltage corresponding to a voltage difference between the V_{SCH} voltage and the V_{SCL} voltage is applied to the Y electrode as a low level voltage of the sustain discharge pulse when the Vs voltage of the sustain pulse is applied to the X electrode.

In addition, the (V_{SCH}−V_{SCL}) voltage is applied as the low level voltage of the sustain pulse to the Y electrode of the first sub-group G₁₁ when the Vs voltage of the sustain pulse is applied to the X electrode during the respective sustain periods Sk₁₂ to Sk₁₈ of the first sub-group G₁₁. After applying one sustain pulse to the Y electrode of the second sub-group G₁₂ during the sustain period Sk₁₂ of the second sub-group G₁₂, the (V_{SCH}−V_{SCL}) voltage is applied as the low level voltage of the sustain pulse to the Y electrode of the second sub-group G₁₂ when the Vs voltage of the sustain pulse is applied to the X electrode.

During the sustain periods Sk₁₃ to Sk₁₈ of the second sub-group G₁₁ and the sustain period S(K+1)₁₁ of the first sub group G₁₁ of the (k+1)th subfield SF(k+1), the (V_{SCH}−V_{SCL}) voltage is applied as the low level voltage of the sustain pulse to the Y electrodes of the second sub-group G₁₂. At this time, since a plurality of discharge cells are reset to be the light emitting state in the reset period R, a sustain discharge is generated when the sustain pulse alternately having the Vs voltage and 0V is applied to the Y electrodes of the second to eighth sub-groups G₁₂-G₁₈ during the sustain period Sk₁₁ of the first sub-group G₁₁.

Therefore, the (V_{SCH}−V_{SCL}) voltage is applied as the low level voltage to the Y electrode of the second to eighth sub-groups G₁₂-G₁₈ during the sustain period Sk₁₁ of the first sub-group G₁₁. At this time, a difference (VS−V_{SCH}+V_{SCL}) between the Vs voltage and the (V_{SCH}−V_{SCL}) corresponds to a voltage that is enough to prevent a sustain discharge from being generated between the X electrode and the Y electrode.

Then, the sustain discharge is not generated between the X and Y electrodes when the (V_{SCH}−V_{SCL}) voltage is applied as the low level voltage of the sustain pulse to the Y electrode. In the case that no sustain discharge is generated between the X and Y electrodes when the Vs voltage is applied to the X electrode, no sustain discharge is generated even though the Vs voltage is subsequently applied to the Y electrode and 0V voltage is applied to the Y electrode since a wall potential of the X electrode is maintained higher than that of the Y electrode. In this way, a subfield having a weight value of 1 can be realized.

The above-described process is equivalently applied to the second row group G₂. That is, after the X electrode and Y electrode are respectively applied with one sustain pulse during the sustain period Sk₂₈ of the eighth sub-group G₂₈ of the second row group G₂, the Y electrode is applied with the (V_{SCH}−V_{SCL}) voltage as the low-level voltage of the sustain pulse while the X electrode is applied with the Vs voltage of the sustain pulse. At this time, the Y electrodes of the seventh to first sub-groups G₂₇ to G₂₁ are applied with the (V_{SCH}−V_{SCL}) voltage as the low-level voltage of the sustain pulse.

In addition, the (V_{SCH}−V_{SCL}) voltage is applied as a low level voltage of the sustain pulse when the Vs voltage is applied to the Y electrode during the respective sustain periods Sk₂₇ to Sk₂₁. In such a way, generation of the sustain discharge in the light emitting cells of the seventh sub-group G₂₇ to the first sub-group G₂₁ are controlled. In the following description related to a weight value, only the first sub-group G₁₁ of the first row group G₁ will be described.

Since a weight value of 2 corresponds to a half length of one sustain period Sk₁ⱼ among sustain periods of the respective sub-groups G₁₁ to G₁₈ or G₂₁ to G₂₈ of one of row groups G₁ and G₂, the (V_{SCH}−V_{SCL}) voltage is applied as a low level voltage of the sustain pulse to the Y electrodes when the Vs voltage of the sustain pulse is applied to the X electrode after two sustain pulses are applied to the Y electrode of the first sub-group G₁₁ during the sustain period Sk₁₁ of the first sub-group G₁₁ in the k-th subfield SFk of the first row group G₁, as shown in FIG. 6C. In addition, the (V_{SCH}−V_{SCL}) voltage is applied as the low level voltage of the sustain pulse to the Y electrode as the Vs voltage of the sustain pulse is applied to the X electrode during the sustain periods Sk₁₂ to Sk₁₈ of the first sub-group G₁₁.

During the sustain period Sk₁₂ of the second sub-group G₁₂, the (V_{SCH}−V_{SCL}) voltage is applied as the low level voltage of the sustain pulse to the Y electrode of the second sub-group G₁₂ as the Vs voltage is applied to the X electrode after applying two sustain pulses to the Y electrode of the second sub-group G₁₂. The (V_{SCH}−V_{SCL}) voltage is applied as the low level voltage of the sustain pulse to the Y electrode of the second sub-group G₁₂ during the sustain periods Sk₁₃ to Sk₁₈ of the second sub-group G₁ₛ and the sustain period S(K+1)₁₁ of the first sub-group G₁₁. The (V_{SCH}−V_{SCL}) voltage is applied as the low level voltage of the sustain pulse to the Y electrode of the second sub-group G₁₂ during the sustain period S₁₁ previous to the address period EA₁₂ of the second sub-group G₁₂. Accordingly, a subfield having the weight value of 2 is realized.

In the k-th subfield SFk of the first row group G₁, when the (V_{SCH}−V_{SCL}) voltage is applied as the low level voltage of the sustain pulse to the Y electrode as the Vs voltage of the sustain pulse is applied to the X electrode during respective sustain periods Sk₁₂ to Sk₁₈ of the first sub-group G₁₁ after applying four sustain pulses to the Y electrode of the first sub-group G₁₁ during the sustain period Sk₁₁ of the first sub-group G₁₁, a subfield having a weight value of 4 can be realized. In addition, a subfield having a weight value of 8 can be realized by applying the (V_{SCH}−V_{SCL}) voltage as the low level voltage of the sustain pulse to the Y electrode as the Vs voltage of the sustain pulse is applied to the X electrode during respective sustain periods Sk₁₃ to Sk₁₈ of the first sub-group G₁₁ after applying four sustain pulses to the Y electrode of the first sub-group G₁₁ during the sustain periods Sk₁₁ and Sk₁₂ of the first sub-group G₁₁.

In the case that the subfield SFk of FIG. 6A has a weight value of 32, all sub-groups G₁₁-G₁₈ of the first row group G₁ experience a sustain discharge when the address period of the first sub-group G₂₁ of the second row group G₂ is performed. When the address period of the first sub-group G₂₁ of the second row group G₂ is performed, a subfield at which six sub-groups G₁₁-G₁₆ among the sub-groups G₁₁-G₁₈ of the first row group G₁ experience the sustain discharge has a weight value of 24 and a sustain at which four sub-groups G₁₁-G14 experience the sustain discharge has a weight value of 16. In addition, a subfield at which two sub-groups G₁₁ and G₁₂ experience the sustain discharge has a weight value of 8, and a subfield at which a subfield G₁₁ experiences the sustain discharge has a weight value of 4. Further, a subfield at which a sub-group G₁₁ partially experiences the sustain discharge has a weight value of less than 4.

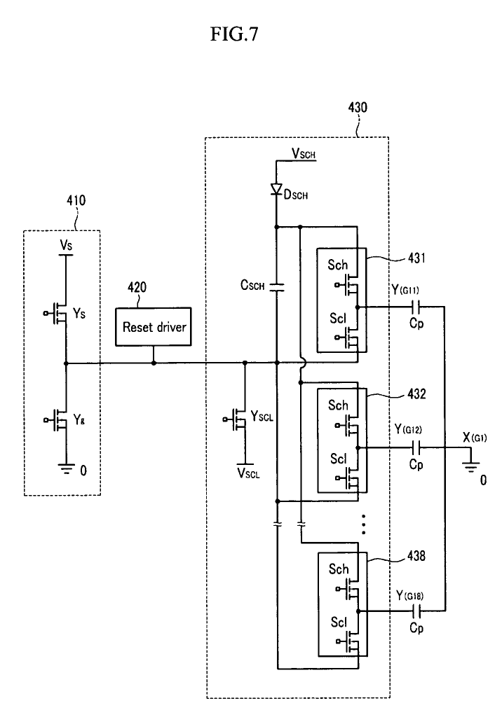

A driving circuit for generating driving waveforms of FIG. 6A to FIG. 6C will now be described in more detail with reference to FIG. 7. A switch used in the description below is provided as an n-channel field effect transistor (FET) having a body diode (not shown), and it can be replaced with another switch that has the same or similar functions. In addition, a capacitive component formed by the X electrode and the Y electrode is described as a panel capacitor Cp.

FIG. 7 shows a driving circuit of the scan electrode driver 400 for generating the driving waveforms of FIG. 6a to FIG. 6C. It is illustrated in FIG. 7 that a driving circuit of the scan electrode driver 400 applies a driving waveform to the Y electrode of the first group G₁. Although each transistor is illustrated as a signal transistor in FIG. 7, each can be formed of a plurality of transistors coupled in parallel.

As shown in FIG. 7, the scan electrode driver 400 includes a sustain driver 410, a reset driver 420, and a scan driver 430.

The scan driver 430 includes selection circuits 431 to 438, a capacitor C_{SCH}, a diode D_{SCH}, and a transistor Y_{SCL}, and the V_{SCL} voltage is applied to Y electrodes of discharge cells to be set as non-light emitting cells during address periods EA1₁₁ to EAL₁₈ of the respective sub-groups G₁₁ to G18 of the first row group G₁ and the V_{SCH} voltage is applied to Y electrodes of discharge cells to which the V_{SCL} voltage is not applied.

In general, the selection circuits 431 to 438 are respectively coupled in the form of integrated circuits (ICs) in order to sequentially select a plurality of Y electrodes Y₁ to Y_{n/2}of the respective sub-groups G₁₁ to G₁₈ during the address periods EA1₁₁ to EAL₁₈, and the driving circuit of the scan electrode driver 400 is commonly coupled to the Y electrodes Y₁ to Y_{n/2} through the selection circuits 431 to 438. The selection circuits 431 to 438 illustrated in FIG. 7 are respectively coupled to one Y electrode among the plurality of Y electrodes of the respective sub-groups G₁₁ to G₁₈ of the first row group G₁.

The selection circuits 431 to 438 respectively include transistors Sch and Scl. A source of the transistor Sch and a drain of the transistor Scl are respectively coupled to the Y electrode. A first end of the capacitor C_{SCH} is coupled to a node of a source of the transistor Scl and a drain of the transistor Sch, and the drain of the transistor Sch is coupled to a second end of the capacitor C_{SCH}. The transistor Y_{SCL} is coupled between a power source V_{SCL} and the Y electrode, and a cathode of the diode D_{SCH} is coupled to the drain of the transistor Sch. An anode of the diode D_{SCH} is coupled to a power source V_{SCH} that supplies a V_{SCH} voltage. Herein, the capacitor C_{SCH} is charged with a (V_{SCH}−V_{SCL}) voltage when the transistor Y_{SCL} is turned on.

The reset driver 420 resets all discharges during a reset period and applies a voltage to the Y electrode so as to set the discharge cells to be in the light emitting state.

The sustain driver 410 includes transistors Ys and Yg, and a drain of the transistor Ys is coupled to a power Vs that supplies a Vs voltage and a source of the transistor Ys is coupled to the Y electrode through the selection circuits 431 to 438. The transistor Yg has a drain coupled to a power source that supplies 0V and a source coupled to the Y electrode. At this time, the transistor Ys applies the Vs voltage to the Y electrode and the transistor Yg applies 0V to the Y electrode.

The scan electrode driver 400 having the above-described configuration operates as follows. During the address periods EA1₁₁ to EAL₁₈ of the respective sub-groups G₁₁ to G₁₈ of the first row group, the transistor Y_{SCL} and the transistor Sch of the selection circuits 431 to 438 are turned on and the V_{SCH} voltage is applied to the Y electrodes of the respective sub-groups G₁₁ to G₁₈ of the first row group G₁ through a current path formed from the power source V_{SCL}, through the transistor YscL and the capacitor CscH that is charged with the (V_{SCH}−V_{SCL}) voltage, to the transistor Sch.

The transistor Sch of the selection circuits 431 to 438 is turned on and the transistor Scl of the selection circuits 431 to 438 is turned on during an address period EAk₁ᵢ of the i-th sub-group G₁ᵢ among the respective sub-groups G₁₁-G₁₈ of the first row group G₁, and thus the V_{SCL} voltage is sequentially applied to the Y electrode of the i-th sub-group G₁ᵢ through a current path formed from the body diode of the transistor Scl of the selection circuits 431 to 348 through the transistor YscL, to the power source V_{SCL}.

Subsequently, the transistor Sch is turned on when another Y electrode of the i-th sub-group G₁ᵢ is selected and thus the V_{SCH} voltage is applied to the Y electrode, and the transistor Y_{SCL} is turned off and the transistor Yg is turned on at the end of the address period EAk₁ᵢ such that 0V voltage is applied to the Y electrode through a current path formed from a ground end 0 through the transistor Yg, to the body diode of the transistor Scl.

During the sustain periods S1₁₁ to SL₁₈ of the respective sub-groups G₁₁ to G₁₈ of the first row group G₁, the transistor Ys is turned on and the transistor Yg is turned off, and thus the Vs voltage is applied to the Y electrodes of the respective sub-groups G₁₁-G₁₈ through a current path formed from the power source Vs through the transistor Ys, to the body diode of the transistor Scl of the selection circuits 431 to 438. Subsequently, the transistor Yg is turned on and the transistor Ys is turned off, and thus 0V is applied to the Y electrodes of the respective sub-groups G₁₁ to G₁₈ through a current path formed from the transistor Scl through the transistor Ys2, to the ground end. The above-described processes are repeated such that a sustain pulse alternately having the Vs voltage and 0V can be applied to the Y electrode.

In addition, the Y electrodes of the respective sub-groups G₁₁ to G₁₈ can be applied with the (V_{SCH}−V_{SCL}) voltage by turning on the transistor Yg and the transistor Sch of the selection circuits 431 to 438 and turning off the transistor Scl of the selection circuits 431 to 438 when the Vs voltage is applied to the X electrode during the sustain periods S1₁₁ to SL₁₈ of the respective sub-groups G₁₁ to G₁₈. At this time, the Y electrode of each sub-group G₁₁ G₁₈ can be individually controlled.

For example, the Vs voltage and 0V are alternately applied to the Y electrode of the first row group G₁₁ during a sustain period Sk₁₁ of the k-th subfield of the first row group G₁ in FIG. 6B. However, the Y electrode of the second row group G₁₂ is alternately applied with the Vs voltage and the (V_{SCH}−V_{SCL}) voltage. In this case, the Y electrodes of the respective sub-groups G₁₁-G₁₈ can be applied with the Vs voltage by turning on the transistor Ys and the transistor scl of the selection circuit 431 to 438 the respective sub-groups G₁₁-G₁₈ and turning off the transistor sch of the selection circuits 431 to 348 of the respective sub-groups G₁₁-G₁₈.

When the transistor Yg and the transistor Sch of the selection circuits 431 of the first sub-group G₁₁ is turned on and the transistor Yg and the transistor Scl of the selection circuit 431 of the first sub-group G₁₁ is turned off, the Y electrode of the first sub-group G₁₁ is applied with the (V_{SCH}−V_{SCL}) voltage and the Y electrodes of the sub-groups G₁₂ to G₁₈ are applied with 0V.

Meanwhile, it is illustrated in 6B and FIG. 6C that the (V_{SCH}−V_{SCL}) voltage is applied as a low voltage of the sustain pulse to the X electrode and the Y electrode in order to prevent generation of a sustain discharge. However, the Y electrode can be floated. When the Y electrode is floated, the transistors Sch and Scl of the selection circuits 431 to 438 are set to be turned off and the selection circuits 431 to 438 are set to be in a high impedance state.

Such floating of the Y electrode causes the voltage of the Y electrode to be changed in accordance with the voltage of the X electrode such that a voltage difference between the X electrode and the Y electrode is reduced, thereby preventing a sustain discharge from being generated in the light emitting cells. In addition, one of the X electrode and the Y electrode can be continuously applied with a high level voltage (Vs) or a low level voltage (0V). For example, the sustain discharge is not generated between the X electrode and the Y electrode since a voltage difference (Vs−Vs) becomes 0 when applying the Vs voltage to the Y electrode while the Vs voltage and 0V are alternately applied to the X electrode.

In the case that the sustain discharge is not generated between the X and Y electrodes when the Vs voltage is applied to the X electrode, a wall potential of the X electrode is maintained higher than that of the Y electrode and thus the sustain discharge is not generated even though the Vs voltage is subsequently applied to the Y electrode and 0V is applied to the X electrode.

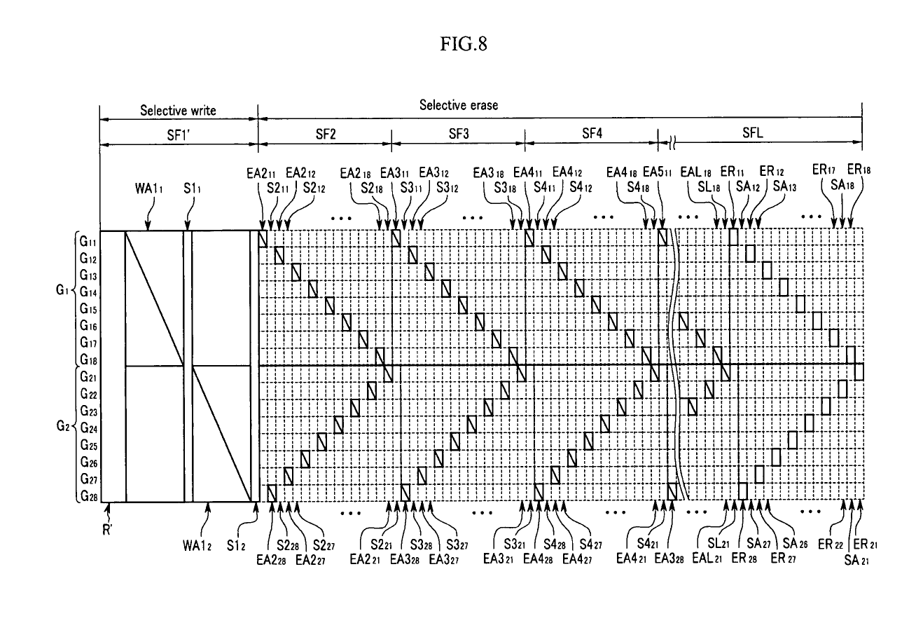

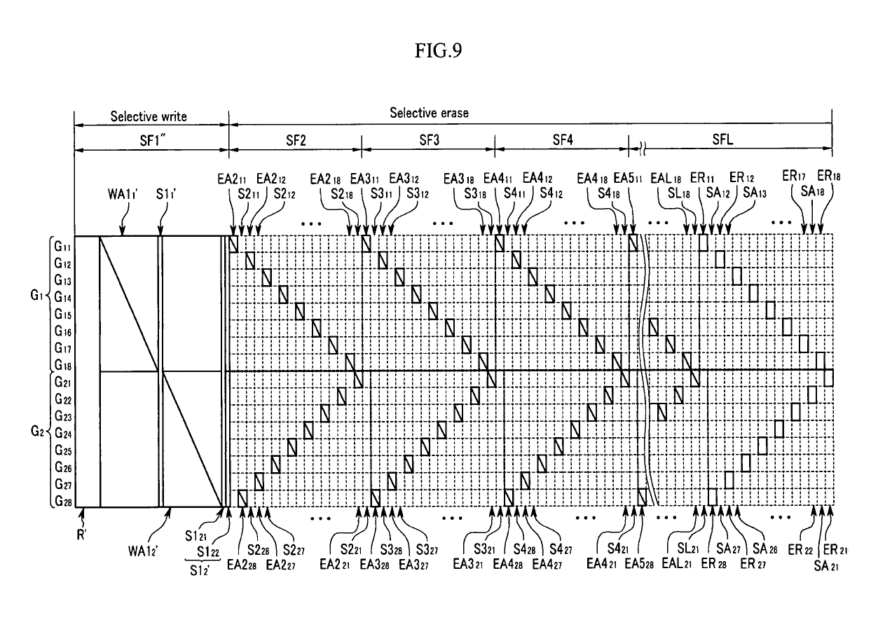

According to the driving method of the first exemplary embodiment of the present invention, a strong reset discharge has to be generated because all the discharge cells are reset in the reset period R previous to the address period of the first subfield SF1 so as to set the discharge cells to the light emitting state. In this case, a black screen looks bright so that the contrast ratio may be degraded. Also, it is difficult to form an amount of wall charges that can set all the discharge cells to be in the light emitting state by only applying the reset period R. A driving method for enhancing the contrast ratio and generating a stable erase discharge will now be described in more detail with reference to FIG. 8 and FIG. 9.

FIG. 8 and FIG. 9 respectively show a driving method of a plasma display device according to second and third exemplary embodiments of the present invention.

As shown in FIG. 8, the driving method according to the second exemplary embodiment is similar to the driving method according to the first exemplary embodiment, except that a selective writing method is used during address periods WA1₁ and WA1₂ of a first subfield SF1′. In addition, in the first subfield SF1′, light emitting cells are selected from among discharge cells that are formed by the plurality of row electrodes during one of the address periods WA1₁ and WA1₂ rather than sub-grouping a plurality of row electrodes of the respective groups G₁ and G₂.

As described, a reset period R′ for resetting light emitting cells to non-light emitting cells is provided before the address periods WA1₁ and WA1₂ in the first subfield SF1′ having the address periods WA1₁ and WA1₂ employing the selective writing method. That is, discharge cells are reset to the light emitting state during the reset period R previous to the address periods EA1₁₁ to EAL₁₈ and EA1₂₁ to EAL₂₈ employing the selective erase method, but the light emitting cells are reset to the non-light emitting state during the reset period R′ before the address periods WA1₁ and WA1₂ employing the selective writing method.

In more detail, discharge cells of the first and second row groups G₁ and G₂ are reset to non-light emitting cells during the reset period R′ of the first subfield SF1′, and the non-light emitting cells are set to be write-discharged during the address periods WA1₁ and WA1₂. Discharge cells set to be light emitting cells among the discharge cells of the first row group G₁ are write-discharged to form wall charges during the address WA1₁, and the light emitting cells of the first row group G₁ are sustain-discharged during the sustain period S1₁. Subsequently, the wall charges formed in the light emitting cells of the first group G₁ are erased. Then, the light emitting cells of the first row group G₁ emit light only during the sustain period S21₁ of the first row group G₁₁.

Discharge cells set to be light emitting cells among the discharge cells of the second row group G₂ are write-discharged to form wall charges during the address period WA1₂, and the light emitting cells of the second row group G₂ are sustain discharged during the second period S1₂. After the sustain discharge, the wall charges formed in the light emitting cells of the second row group G₂ are erased.

As described, according to the second exemplary embodiment of the present invention, a sustain discharge is generated during the sustain periods S21₁ and S21₂ after a write-discharge is sequentially generated in the plurality of row electrodes of the first and second groups G₁ and G₂during the address periods WA1₁ and WA1₂, and thus light emitting cells are selected. In this way, subfields SF2 to SFL having address periods that employ the selective writing method can be performed after a sufficient amount of wall charges are formed in each electrode of the light emitting cells.

Meanwhile, in order to erase wall charges formed on the light emitting cells of the respective groups G₁ and G₂ after the sustain periods S1₁ and S1₂ of the respective groups G₁ and G₂ in the first subfield SF1′, the width of the last sustain pulse may be set to be greater than the widths of other sustain pulses so as to prevent wall charges from being formed during the sustain periods S1₁ and S1₂ of the respective groups G₁ and G₂. In addition, wall charges formed by the sustain discharge can be erased by applying a waveform (e.g., a waveform changed in a ramp pattern) that can gradually change a voltage of each electrode after applying the last sustain pulse.

In addition, a gradually increasing voltage and a gradually decreasing voltage may be used to realize the reset period R′ in order to reset light emitting cells to non-light emitting cells during the reset period R′ before the address periods WA1₁ to WA1₂ employing the selective writing method. That is, the reset period R′ can be realized by gradually increasing the voltage of the plurality of Y electrodes and then gradually decreasing the voltage of the plurality of Y electrodes. A weak reset discharge is generated between the X and Y electrodes while the voltage of the Y electrode increases such that wall charges are formed in the discharge cells, and then the wall charges are erased by a weak reset discharge generated while the voltage of the Y electrode decreases, such that the discharge cells are reset to non-light emitting cells. Therefore, the contrast ratio can be improved since no strong discharge is generated during the reset period R1.

However, an erasing operation for erasing the wall charges formed in the discharge cells of the respective groups G₁ and G₂ may not be applied after the sustain periods S1₁ and S1₂ of the respective groups G₁ and G₂ as in the second exemplary embodiment of FIG. 8.

In more detail, as shown in FIG. 9, discharge cells set to be light emitting cells among the discharge cells of the first row group G₁ are write-discharged during an address period WA1₁ of a first subfield SF″ so as to form wall charges, and the light emitting cells of the first row group G₁ are sustain-discharged during the sustain period S1₁. At this time, a minimum number (e.g., once or twice) of sustain discharges is set to be generated during the sustain period S1₁.

Subsequently, wall charges are formed by write-discharging discharge cells that are set to be light emitting cells among discharge cells of the second row group G₂ during the address period WA1₂ of the first subfield SF1″ and the light emitting cells of the first and second groups G₁ and G₂ are sustain-discharged during a partial period S1₂₁ of the sustain period S1₂. In addition, the light emitting cells of the second row group G₂ are sustain-discharged and the light emitting cells of the first row group G₁ are not sustain-discharged while the light emitting cells of the first row group G₁ are in the state of not being sustain-discharged during a partial period S1₂₂ of the sustain period S1₂. At this time, the number of sustain discharges generated in the light emitting cells of the second row group G₂ during the partial period S1₂₂ among the sustain period S1₂ is set to correspond to the number of sustain discharges generated in the light emitting cells of the first row group G₁ during the sustain period S1₂.

Also, in the case that the two sustain periods S1₁ and S1₂ do not satisfy a weight value of the first subfield SF1″, the light emitting cells of the first and second groups G₁ and G₂can be additionally sustain-discharged during the partial period S1₂₂ of the sustain period S1₂.

Although the erase periods ER1₁₂ to ER1₁₈ and ER1₂₂ to ER1₂₈ and additional sustain periods SA₁₂ to SA₁₈ and SA₂₂ to SA₂₈ of the first and second groups are formed in the last subfield SFL of a field according to the first to third exemplary embodiments of the present invention, the erase periods and the sustain periods can be eliminated. In the case of eliminating the erase periods ER1₁₂ to ER1₁₈ and ER1₂₂ to ER1₂₈ and the additional sustain periods SA₁₂ to SA₁₈ and SA₂₂ to SA₂₈, an addressing order of the respective sub-groups G₁₁ to G₁₈ and G₂₁ to G₂₈ of the respective groups G₁ and G₂ can be changed throughout each field. As such, the same number of sustain discharges can be generated in each row group.

In addition, unlike the first to third exemplary embodiments of the present invention, it is possible to set no sustain discharge to be generated from a point at which the erase periods ER1₁₂ to ER1₁₈ and ER1₂₂ to ER1₂₈ of the first and second row groups G₁ and G₂ are applied in order to ensure that the same number of sustain discharges is generated in each row group. That is, as shown in FIG. 6B and FIG. 6C, the (V_{SCH}−V_{SCL}) voltage is applied to the X electrode as the Vs voltage is applied to the X electrode and the Vs voltage is applied to the Y electrode as 0V is applied to the X electrode from the point at which the erase periods ER1₁₂ to ER1₁₈ and ER1₂₂ to ER1₂₈ of the first and second row groups G₁ and G₂ are applied. Then, no sustain discharge is generated from the point at which erase periods ER1₁₂ to ER1₁₈ and ER1₂₂ to ER1₂₈ of the first and second row groups G₁ and G₂ are applied.

In the third exemplary embodiment, assume that the selective erase method is employed, the width of the scan pulse is 0.7 μs, one sustain period has eight sustain pulses, one sustain pulse takes a time of 5.6 μs, 1024 row electrodes are driven under this circumstance, and the sustain pulse has a high level voltage and a low level voltage. Then, the length of the sustain period becomes 44.8 μs(=5.6 μs×8), and the length of the address period becomes 44.8 μs(=0.7 μs×64 rows). Accordingly, the length of one subfield becomes 716.8 μs(=44.8 μs×16).

In addition, in the case that the selective writing method is employed, the width of the scan pulse is 1.3 μs and the length of the reset period is 350 μs, so the length of the address period becomes 665.6 μs(=1.3 μs×512 rows). At this time, a total length (S1₁+S1₂) Of the sustain periods becomes 14 μs(=5.6 μs×2.5) when the weight value is 1 under an assumption that one sustain pulse is applied during the sustain period S1₁ and 1.5 sustain pulses are applied during the sustain period S1₂. Accordingly, the length of the subfield SF1 becomes 1695.2 μs(=350 μs+665.6 μs×2+14 μs).

That is, in the third exemplary embodiment, since 14970.8 μs(=16666−1695.2) of time is allocated to a subfield that employs the selective erase method in a field, one field may be formed of 20 (=14970.8/716.8) subfields that employ the selective erase method.

In addition, although it is illustrated in FIG. 6A to FIG. 6C that the sustain pulse alternately having the Vs voltage and 0V voltage is applied to the X electrode and Y electrode in opposite phase, a sustain pulse in another pattern may also be applied. That is, a sustain pulse alternately having the Vs voltage and the −Vs voltage may be applied to the Y electrode while the X electrode is biased with 0V voltage.

As described above, a plurality of row electrodes are divided into first and second row groups, and row electrodes of each group are divided into a plurality of sub-groups according to the exemplary embodiment of the present invention. In addition, an address period is applied to each sub-group of the first and second row groups in each subfield of a field, and a sustain period is performed between the address periods of the respective sub-groups. An address period is applied to each sub-group of the second row group while a sustain period is applied to each sub-group of the first row group, and a sustain period is applied to each sub-group of the first row group while an address period is applied to each sub-group of the second row group.

Accordingly, the length of a subfield can be reduced without dividing the sustain period and the address period since the sustain period can be applied while the address period is applied. Further, the address period is positioned between the respective sustain periods of respective sub-groups such that priming particles formed during the sustain period can be efficiently used, thereby reducing the width of the scan pulse and achieving high-speed scan.

In addition, in the case that the address period of each subfield employs the selective erase method, subfields that are consecutive until an occurrence of an erase discharge express grayscales, and thereby a dynamic false contour can be avoided.

Further, power consumption can be reduced since expression of any grayscale requires one erase discharge. At this time, a sufficient amount of wall charges can be formed by applying the selective writing method to an address period of the temporally first subfield, and therefore a subfield to which the selective erase method is applied later experiences a stable erase discharge. An occurrence of a storing discharge can be prevented by applying a voltage that gradually increases and gradually decreases during a reset period of the subfield to which the selective writing method is applied, thereby improving the contrast ratio.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving method for driving a plasma display device by a plurality of subfields divided from a field, the plasma display device having a plurality of row electrodes, a plurality of column electrodes, and a plurality of discharge cells respectively formed by the row and column electrodes, the driving method comprising:
dividing the plurality of row electrodes into a first row group and a second row group, dividing row electrodes of the first row group into a plurality of sub-groups, and dividing row electrodes of the second row group into a plurality of sub-groups;
in a first subfield of a first subfield group among the plurality of subfields, selecting non-light emitting cells among discharge cells of one sub-group among the plurality of sub-groups of the first row group during a first period, sustain-discharging light emitting cells of at least one first sub-group among the sub-groups of the second row group, and not sustain-discharging light emitting cells of at least one second sub-group among the plurality of sub-groups; and
in the first subfield, selecting non-light emitting cells among light emitting cells of a sub-group among the plurality of sub-groups of the second row group during a second period, sustain-discharging light emitting cells of at least one third sub-group among the plurality of sub-groups of the first row group, and not sustain-discharging light emitting cells of at least one fourth sub-group among the plurality of sub-groups of the first row group.

2. The driving method of claim 1, wherein in a second subfield of the first subfield group among the plurality of subfields, sustain-discharging the plurality of sub-groups of the second row group during the first period.

3. The driving method of claim 1, wherein light emitting cells of at least one fifth sub-group among the plurality of sub-groups of the second row group are sustain-discharged during a partial period of the first period.

4. The driving method of claim 1, wherein a period during which light emitting cells of at least one first sub-group among the plurality of sub-groups of the second row group is shorter than the first period.

5. The driving method of claim 1, wherein the plurality of row electrodes comprise a plurality of first electrodes and a plurality of second electrodes that perform a display operation together with the plurality of first electrodes, each row electrode formed by the first electrode and the second electrode;
the sustain-discharging of the light emitting cells of the at least one first sub-group among the plurality of sub-groups of the second row group comprises applying a first sustain pulse and a second sustain pulse in opposite phase to the first and second electrodes of at least one first sub-group at least once, the first and second sustain pulses respectively having a high level voltage and a low level voltage; and
the not sustain-discharging of the light emitting cells of the at least one second sub-group of the plurality of sub-groups of the second row group comprises applying the first sustain pulse to the first electrode of the at least one second sub-group and floating the second electrode.

6. The driving method of claim 1, wherein the plurality of row electrodes comprise a plurality of first electrodes and a plurality of second electrodes that perform a display operation together with the plurality of first electrodes, each row electrode formed by the first electrode and the second electrode,
the selecting of the non light emitting cells among the light emitting cells of the at least one sub-group among the plurality of sub-groups of the first row group during the first period comprises:
sequentially applying a first voltage to the plurality of second electrodes of the at least one sub-group among the plurality the sub-groups of the first row group; and
applying a second voltage that is higher that the first voltage to second electrodes of the plurality of sub-groups of the first row group, wherein the second electrodes to which the second voltage is applied are not applied with the first voltage.

7. The driving method of claim 6, wherein the sustain-discharging the light emitting cells of the at least one first sub-group among the plurality of sub-groups of the second row group comprises applying a first sustain pulse and a second sustain pulse in opposite phase to the first and second electrodes of the at least one first sub-group at least once, the first and second sustain pulses respectively having a high level voltage and a low level voltage, and
the not sustain-discharging of the light emitting cells of the at least one second sub-group among the plurality of sub-groups of the second row group comprises:
applying the first sustain pulse to the first electrode of the at least one second sub-group;
applying a voltage that corresponds to a voltage difference between the first and second voltages to the second electrode of the at least one second sub-group while the high level voltage of the first sustain pulse is applied to the first electrode of the at least one second sub-group; and
applying the high level voltage to the second electrode of the at least one second sub-group while the low level voltage of the first sustain pulse is applied to the first electrode of the at least one second sub-group.

8. The driving method of claim 1, wherein the plurality of row electrodes comprises a plurality of first electrodes and a plurality of second electrodes that perform a display operation together with the plurality of first electrodes, each row electrode formed by the first electrode and the second electrode,
the sustain-discharging of the light emitting cells of the at least one first sub-group among the plurality of sub-groups of the second row group comprises applying a first sustain pulse and a second sustain pulse in opposite phase to the first and second electrodes of at least one first sub-group at least once, the first and second sustain pulses respectively having a high level voltage and a low level voltage, and
the not sustain-discharging of the light emitting cells of the at least one second sub-group of the plurality of sub-groups of the second row group comprises:
applying the first sustain pulse to the first electrode of the at least one second sub-group; and
applying one of the high level voltage and the low level voltage of the second sustain pulse to the second electrode of at least one second sub-group while the high level voltage of the first sustain pulse is applied to the first electrode of the at least one second sub-group.

9. The driving method of claim 1, in a third subfield consecutively positioned ahead of the first subfield group with regard to time, further comprising:
setting the plurality of discharge cells to be non-light emitting cells;
selecting light emitting cells from discharge cells of the first row group and sustain-discharging the light emitting cells of the first row group; and
selecting light emitting cells from discharge cells of the second row group and sustain-discharging the light emitting cells of the second row group.

10. The driving method of claim 9, wherein, in the third subfield,
the light emitting cells of the first row group are not sustain-discharged during a partial period among a sustain-discharge period of the light emitting cells of the second row group that are sustain-discharged, and
the light emitting cells of the first row group are sustain-discharged during the sustain-discharge period of the light emitting cells of the second row group, excluding the partial period.

11. The driving method of claim 1, wherein partial first subfields of the first subfield group have the same weight values as each other, and the rest of the first subfields of the first subfield group respectively have weight values that are less than the weight values of the partial first subfields.

12. A plasma display device comprising:
a plasma display panel (PDP) including a plurality of row electrodes that perform a display operation, a plurality of column electrodes formed crossing the row electrodes, and a plurality of discharge cells formed by the plurality of row electrodes and the plurality of column electrodes;
a controller for dividing one field into a plurality of subfields, dividing the plurality of row electrodes into a first row group and a second row group, dividing row electrodes of the first row group into a plurality of sub-groups, and dividing row electrodes of the second row group into a plurality of sub-groups; and
a driver for driving the plurality of row and column electrodes,
wherein, in at least one first subfield of a plurality of consecutive first subfields among the plurality of subfields, the driver selects non-light emitting cells from light emitting cells of the respective sub-groups during a first period of the respective sub-groups of the first row group, sustain-discharges the light emitting cells of at least one first sub-group among the plurality of sub-groups of the second row group, and non sustain-discharges light emitting cells of at least one second sub-group among the plurality of sub-groups of the second row group, and
in the first subfield, selects non-light emitting cells from light emitting cells of the respective sub-groups during a second period of the respective sub-groups of the second row group, sustain-discharges light emitting cells of at least one third sub-group among the plurality of sub-groups of the first row group, and non sustain-discharges light emitting cells of at least one fourth sub-group among the plurality of sub-groups of the first row group.

13. The plasma display device of claim 12, wherein the plurality of row electrodes comprises a plurality of first electrodes and a plurality of second electrodes that perform a display operation together with the plurality of first electrodes, each row electrode formed by the first and second electrodes, and
the driver applies a first sustain pulse and a second sustain pulse in opposite phase to the first and second electrodes of the at least one first sub-group at least once and sustain-discharges light emitting cells of the first sub-group, the first and second sustain pulse respectively having a high level voltage and a low level voltage, and
applies the first sustain pulse to the first electrode of the at least one second sub-group and floats the second electrode such that it prevents the light emitting cells of the second sub-group from being sustain-discharged.

14. The plasma display device of claim 13, wherein the driver comprises a first switch and a second switch respectively having a first end coupled to the plurality of second electrodes of the second row group and a plurality of selection circuits for applying one of a second end voltage of the first switch and a second end voltage of the second switch to the corresponding second electrodes of the second row group, and floats the second electrode by turning off the first and second switches.

15. The plasma display device of claim 12, wherein the plurality of row electrodes comprise a plurality of first electrodes and a plurality of second electrodes that perform a display operation together with the plurality of first electrodes, each row electrode formed by the first electrode and the second electrode; and
wherein the driver,
in the first period, sequentially applies a first voltage to the plurality of second electrodes of the at least one sub-group among the plurality of sub-groups of the first row group, and applies a second voltage that is higher than the first voltage to the rest of the second electrodes of the plurality of sub-groups of the first row group to select non-light emitting cells,
applies a first sustain pulse and a second sustain pulse in opposite phase to the first and second electrodes of the at least one first sub-group at least once to sustain discharge the light emitting cells of the first sub-group, the first and second sustain pulses respectively having a high level voltage and a low level voltage, and
applies the high level voltage of the first sustain pulse to the first electrode of the at least one second sub-group and applies a third voltage that corresponds to a voltage difference between the first and second voltages to the second electrode to the second electrode to prevent the light emitting cells of the second sub-group from being sustain-discharged.

16. The plasma display device of claim 15, wherein the driver comprises:
a plurality of selection circuits respectively coupled to the plurality of second electrodes of the second row group, respectively having a first end and a second end, and applying one of a voltage of the first end and a voltage of the second end;
a first switch coupled between the second ends of the selection circuit and a first power source that supplies the first voltage;
a capacitor for charging the third voltage, and that is coupled between the first end and the second end of the selection circuit;
a second switch coupled between a second power source for supplying the high level voltage and the plurality of second electrodes of the second row group; and
a third switch coupled between a third power source for supplying the low level voltage and the plurality of second electrodes of the second row group, and
the driver turns on the first switch to apply the third voltage to the second electrode of at least one second sub-group through the first end of a selection circuit of the at least one second sub-group.

17. The plasma display device of claim 12, wherein, in a consecutive third subfield provided temporally before the plurality of first subfields in regard to time,
the driver selects light emitting cells from discharge cells of the first row group and sustain-discharges the light emitting cells of the first row group, and selects light emitting cells of the second row group and sustain-discharges the light emitting cells of the second row group.

18. The plasma display device of claim 17, wherein the driver sets the plurality of discharge cells to be non-light emitting cells before selecting the light emitting cells in the third subfield.

19. The plasma display device of claim 18, wherein the controller groups row electrodes formed in an upper portion of the PDP among the plurality of row electrodes into the first row group, and groups row electrodes formed in a lower portion of the PDP among the plurality of row electrodes into the second row group.

20. The plasma display device of claim 18, wherein the controller groups odd-numbered row electrodes among the plurality of row electrodes into the first row group, and groups even-numbered row electrodes among the plurality of row electrodes into the second row group.
